(19) United States
(12) Patent Application Publication
(10) Pub. No.: US 2006/0090167 A1
(43) Pub. Date: Apr. 27, 2006

(54) Administering return data from execution of commands by a computer operating system

(75) Inventors: Susann Marie Keohane, Austin, TX (US); Gerald Francis McBrearty, Austin, TX (US); Shawn Patrick Mullen, Buda, TX (US); Jessica Murillo, Hutto, TX (US); Johnny Meng-Han Shieh, Austin, TX (US)

Correspondence Address: INTERNATIONAL CORP (BLF), c/o BIGGERS & OHANIAN, LLP, P.O. BOX 1469, AUSTIN, TX, 78767-1469, US

(73) Assignee: INTERNATIONAL BUSINESS MACHINES CORPORATION, ARMONK, NY (US)

(21) Appl. No.: 10/960,565

(22) Filed: Oct. 7, 2004

(51) Int. Cl. G06F 9/44

(52) U.S. Cl. 719/319

(57) ABSTRACT

Administering return data from execution of commands by a computer operating system including receiving in the operating system a command name and optional command parameters specifying a command for current execution, the command having been previously executed, and displaying return data from the previous execution of the command. Typical embodiments include marking the command in a history file upon the previous execution of the command, including recording a display buffer location of the return data from the previous execution of the command. In such embodiments, displaying return data from the previous execution of the command includes retrieving from the history file the display buffer location of the return data from the previous execution of the command and reading from a display buffer the return data from the previous execution of the command in dependence upon display buffer location.

### BACKGROUND OF THE INVENTION

1. Field of the Invention

The field of the invention is data processing, or, more specifically, methods, systems, and products for administering return data from execution of commands by a computer operating system.

2. Description of Related Art

A user entering command lines through a command line interface to a shell of an operating system, encounters substantial inconsistencies in CPU performance on the user's computer, network performance, and server performance, each of which can represent annoying or even harmful delays in command response with return data.

Consider an example of a user who enters a command to retrieve contact information on a colleague:
>CONTACT SHAWN MULLEN

and receives display return data:

| NAME | EXT | OFFICE | EMAIL |
|---|---|---|---|
| Mullen, Shawn | 3508 | 5019 | shawnm@ibm.com |

A few minutes later, the user realizes that the user forgot to take note of the telephone extension number. The user can re-enter the command, but the command hangs because the local system is busy, or the network is slow, or the server is busy, or some combination of these. The user knows the telephone number has not changed in the last few minutes, and the return data from the previous execution of the command is still buffered in the display window of the command line interface. It is awkward and time consuming to scroll up through the display window to look up the previous return data. There is need for improvement in administering return data from execution of commands by a computer operating system.

### SUMMARY OF THE INVENTION

Methods, systems, and products are disclosed for administering return data from execution of commands by a computer operating system that enable convenient retrieval and display of return data from previous executions of commands. Methods, systems, and products are disclosed for administering return data from execution of commands by a computer operating system that include receiving in the operating system a command name and optional command parameters specifying a command for current execution, the command having been previously executed, and displaying return data from the previous execution of the command. In typical embodiments, the command is an executable file of the computer operating system, receiving the command name and command parameters is carried out by a shell process of the operating system, and the previous execution of the command is carried out by forking a child process of the shell process and executing the command by the child process.

Typical embodiments include attempting to execute the command and display current return data from the command, where the command may fail to execute—fail to execute for many reasons including timing out or interruption by user action. In typical embodiments, receiving the name and parameters specifying a command for current execution may include receiving an instruction to display the return data from the previous execution of the command.

Typical embodiments also include marking the command in a history file upon the previous execution of the command, including recording a display buffer location of the return data from the previous execution of the command. In such embodiments, displaying return data from the previous execution of the command includes retrieving from the history file the display buffer location of the return data from the previous execution of the command and reading from a display buffer the return data from the previous execution of the command in dependence upon display buffer location.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of automated computing machinery comprising an exemplary computer useful in rendering images on a video graphics adapter according to embodiments of the present invention.

FIG. 2 sets forth a flow chart illustrating an exemplary method of administering return data from execution of commands by a computer operating system.

FIGS. 3A, 3B, and 3C set forth a pseudocode program listing illustrating an exemplary method of administering return data from execution of commands by a computer operating system.

### DETAILED DESCRIPTION OF EXEMPLARY EMBODIMENTS

### INTRODUCTION

The present invention is described to a large extent in this specification in terms of methods for administering return data from execution of commands by a computer operating system. Persons skilled in the art, however, will recognize that any computer system that includes suitable programming means for operating in accordance with the disclosed methods also falls well within the scope of the present invention. Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit.

The invention also may be embodied in a computer program product, such as a diskette or other recording medium, for use with any suitable data processing system. Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specificafion are oriented to software installed and executing on computer hardware, nevertheless, alternative embodiments implemented as firmware or as hardware are well within the scope of the present invention.

### Administering Return Data From Execution of Commands by a Computer Operating System

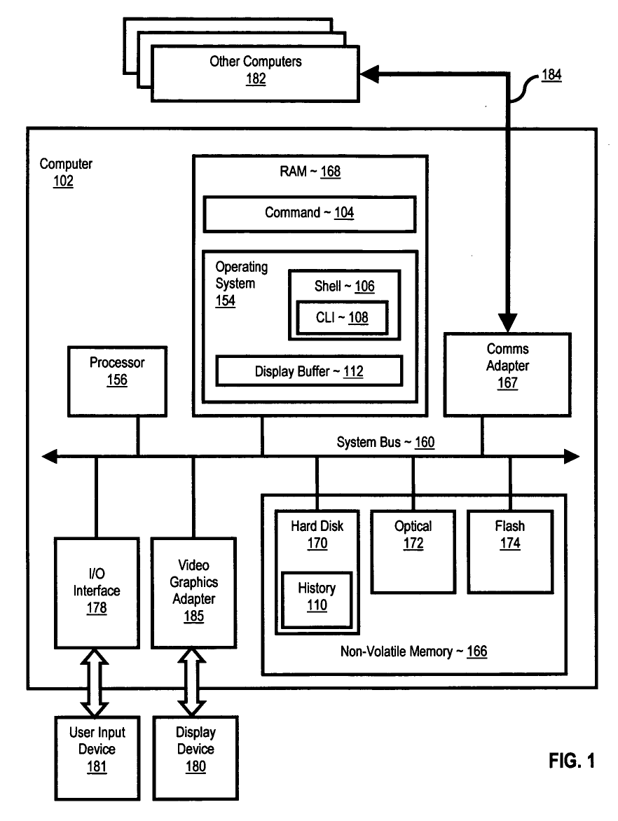

Rendering images on a video graphics adapter in accordance with the present invention is generally implemented with computers, that is, with automated computing machinery. For further explanation, FIG. 1 sets forth a block diagram of automated computing machinery comprising an exemplary computer (102) useful in rendering images on a video graphics adapter according to embodiments of the present invention. The computer (102) of FIG. 1 includes at least one computer processor (156) or ‘CPU’ as well as random access memory (168) (“RAM”).

Also stored in RAM (168) is an operating system (154). Operating systems useful in computers according to embodiments of the present invention include Unix™, Linux™, AIX™, Microsoft Windows NT™, and many others as will occur to those of skill in the art. Operating system (154) in the example of FIG. 1 is shown in RAM (168), but many components of an operating system may be stored in non-volatile memory (166) also.

The operating system (154) of computer (102) is programmed to administer return data from execution of commands according to embodiments of the present invention by receiving in the operating system a command name and optional command parameters specifying a command for current execution for a command that has been previously executed and displaying return data from the previous execution of the command. The command (104) typically is an executable file of the computer operating system, and receiving the command name and command parameters typically is carried out by a shell process (106) of the operating system. A ‘shell,’ sometimes called a ‘command shell,’ is a command processor interface for an operating system. A command processor is a program that executes operating system commands. In this example and as described in more detail below in this specification, the shell executes commands by forking a child process of the shell process and executing the commands by the child process. The form of command processor interface varies from shell to shell, including, for example, graphical user interfaces or ‘GUIs,’ menu interfaces, and command line interfaces or ‘CLIs.’ The shell (106) of computer (102) supports a CLI (108), a command line interface that prompts users with a prompt on a display screen to type a command on a keyboard and enter the command as input by pressing a RETURN or ENTER key.

It may be useful to display return data from the previous execution of the command for several reasons. A user may know that a command that takes a long time to run was run previously and specifically instruct the shell to display the previous return data to avoid waiting. A command may ‘hang’ upon execution, taking an undesirably long time to run or even failing complete. The may hang because the computer system is too busy, or a network is too slow, or a server is too busy, or for many other reasons that can cause an undesirably long delay in execution. A command may fail to execute successfully because a user changes his mind or gets tired of waiting and interrupting execution of the command with a keyboard instruction, control-C, control-Z, or the ESCAPE key, for example.

The shell marked the command in a history file (110) upon the previous execution of a command, including recording a display buffer location of the return data from the previous execution of the command. The return data is stored in a display buffer (112) at the location recorded in the history file. The shell then displays return data from the previous execution of the command by retrieving from the history file the display buffer location of the return data from the previous execution of the command and reading the return data from the previous execution of the command from the display buffer location recorded in the history file for the command.

The computer (102) of FIG. 1 includes non-volatile computer memory (166) coupled through a system bus (160) to processor (156) and to other components of the computer. System bus (160) may be a PCI bus, an AGP bus, an ISA bus, or others that may occur to those of skill in the art. Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The exemplary computer (102) of FIG. 1 includes a communications adapter (167) for implementing connections for data communications (184), including connections through networks, to other computers (182), including servers, clients, and others as will occur to those of skill in the art. Communications adapters implement the hardware level of connections for data communications through which local devices and remote devices or servers send data communications directly to one another and through networks. Examples of communications adapters useful in a system for administering return data from execution of commands according to embodiments of the present invention include modems for wired dial-up connections, Ethernet (IEEE 802.3) adapters for wired LAN connections, and 802.11b adapters for wireless LAN connections.

The example computer of FIG. 1 includes one or more input/output interface adapters (178). Input/output interface adapters in computers implement user-oriented input/output through, for example, software drivers and computer hardware, such as video graphics adapter (185), for controlling output to display devices (180) such as computer display screens, as well as user input from user input devices (181) such as keyboards and mice.

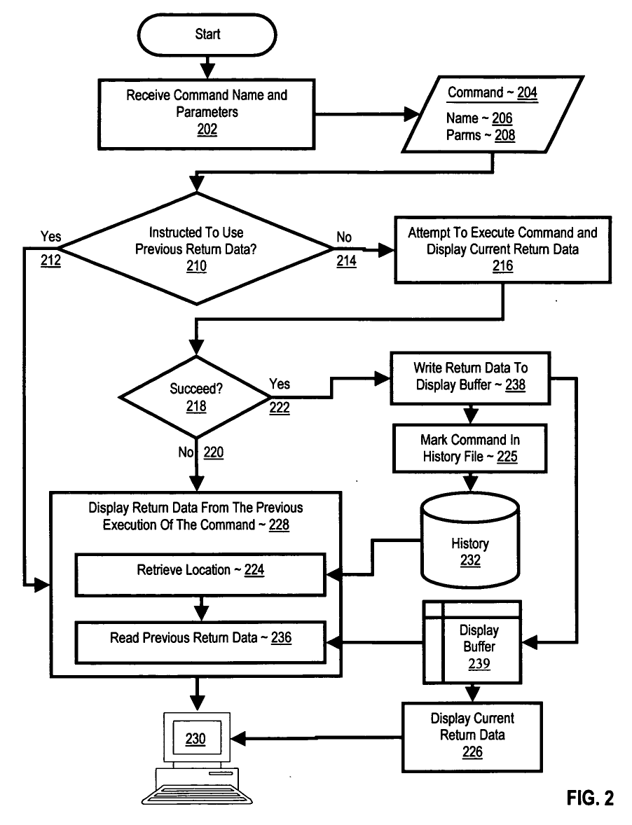

For further explanation, FIG. 2 sets forth a flow chart illustrating an exemplary method of administering return data from execution of commands by a computer operating system that includes receiving (202) in the operating system a command name (206) and optional command parameters (208) specifying a command (204) for current execution, the command having been previously executed. The method of FIG. 2 also includes displaying (228) return data from the previous execution of the command.

In the method of FIG. 2, the command (204) may be an executable file of the computer operating system. In the method of FIG. 2, receiving (202) the command name and command parameters may be carried out by a shell process of the operating system. In addition, the previous execution of the command may be carried out by forking a child process of the shell process and executing the command by the child process.

In the method of FIG. 2, receiving (202) the command name (206) and command parameters (208) specifying a command (204) for current execution may include receiving an instruction (210) to display the return data from the previous execution of the command. Such an instruction may be implemented on any command by, for example, setting a flag on a command line that instructs a shell to display return data from a previous execution of the command. Assume this command line is entered through a keyboard at a CLI prompt on a computer display screen:
>CONTACT SHAWN MULLEN

In this example, CONTACT is a name of command that takes as parameters an employee's first name and last name and return the employee's name, phone extension number, office number, and email address. In this example, the return data may be:

| NAME | EXT | OFFICE | EMAIL |
|---|---|---|---|
| Mullen, Shawn | 3508 | 5019 | shawnm@ibm.com |

This return data is some quantity of data, in fact, about 64 bytes including white space, now stored at a display buffer storage location—and therefore also displayed on the display screen below the command line. On a subsequent command line, entered because the user forgot to write down Shawn's extension number and does not want to take the time to scroll through back through the display buffer to look for it, the user may enter the command as:
>CONTACT SHAWN MULLEN /RPD
   where the /RPD flag instructs the shell to display return data from a previous execution of the command. In this example, the shell may display:

USING PREVIOUS RETURN DATA:

| NAME | EXT | OFFICE | EMAIL |
|---|---|---|---|
| Mullen, Shawn | 3508 | 5019 | shawnm@ibm.com |

That is, the shell warns or advises the user that the displayed return data is return data from a previous execution of the command. In this example, the shell does not execute the command, nor does the shell even attempt to execute the command. Instead, as shown on FIG. 2, the shell checks (210) command flags to determine whether the command has a flag instructing the shell to use previous return data and, if there is such a flag, the shell proceeds directly (212) display return data from the previous execution of the command.

The method of FIG. 2 includes determining (210) whether such an instruction is received and, if so (212), proceeding directly to display (228) return data from the previous execution of the command.

When there is no express instruction (214) to display the previous return data, the method of FIG. 2 also includes attempting (216) to execute the command and display current return data (226) from the command, where the command may fail (220) to execute. The command may fail to execute because the command times out, because the system is busy, or a network is slow, or a server is busy, or for any reason that may cause an undesirably long delay in execution. The command may fail to execute because a user interrupts execution of the command by, for example, entry of a keyboard keystroke for such interruptions, control-C, control-G, control-Z, or the ESCAPE key. Other factors causing failure to execute will occur to those of skill in the art, and all such factors are well within the scope of the present invention.

The method of FIG. 2 includes determining (218) whether the command executes successfully (222), and, if it fails (220), displaying (228) return data from the previous execution of the command. In the method of FIG. 2, displaying (228) return data from the previous execution of the command includes retrieving (224) from the history file (232) the display buffer location of the return data from the previous execution of the command and reading (236) from a display buffer (239) the return data from the previous execution of the command in dependence upon display buffer location.

If the command executes successfully (222), the method of FIG. 2 includes writing (238) the current return data to a display buffer (239) and marking (225) the command in a history file (232). Writing (238) the current return data to a display buffer (239) may include noting the memory address or buffer offset where the current return data is written into the buffer and noting the quantity of return data written into the buffer. Marking (225) the command in a history file (232) may be carried out by marking the command name with tags from a markup language such as, for example, XML, the eXtensible Markup Language. Marking (225) the command in a history file (232) may include marking the command with the memory address or buffer offset where its return data is written in the display buffer—so that it can be retrieved and used for display later when, for example, a subsequent execution of the command fails. Readers should note at this point that this current writing (238) of return data to a display buffer (239) and marking (225) the command in a history file (232) in fact represent marking the command in a history file upon the previous execution of the command, including recording a display buffer location of the return data from the previous execution of the command, because a successful execution of the command is, for future failed or interrupted executions of the command, a successful previous execution.

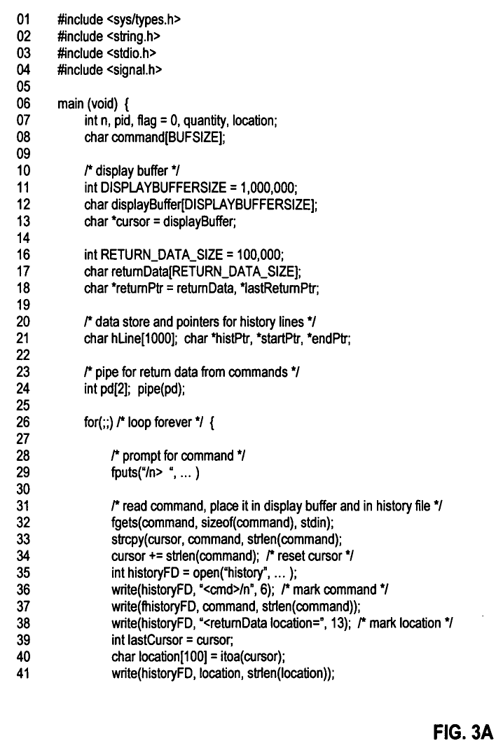

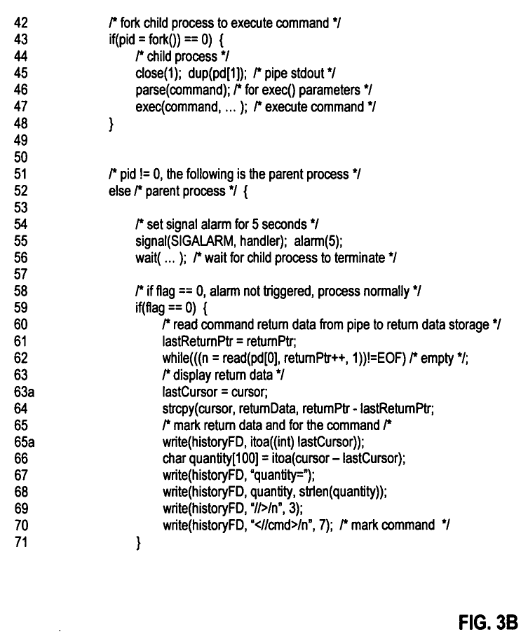

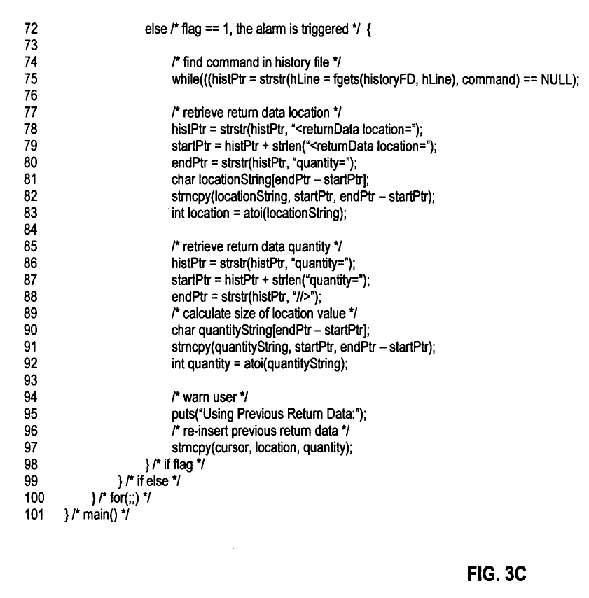

For further explanation of administering return data from execution of commands by a computer operating system according to embodiments of the present invention, FIGS. 3A, 3B, and 3C set forth a pseudocode program listing illustrating an exemplary method of administering return data from execution of commands by a computer operating system. The example of FIGS. 3A, 3B, and 3C uses the general form of source code written in the C programming language, with the addition of line numbers down the left column of the listing, but the listing of FIGS. 3A, 3B, and 3C is referred to as ‘pseudocode’ because it is an explanation in the form of code rather than an actual program listing. The line numbers in the illustrated listing continue from 01 through 101 sequentially across FIGS. 3A, 3B, and 3C, illustrating a single pseudocode program listing. For brevity and clarity of explanation, therefore, this specification will not continue to refer separately to FIGS. 3A, 3B, and 3C, but will instead refer to the example illustrated in FIGS. 3A, 3B, and 3C simply as ‘the illustrated program.’

The overall plan of the illustrated program is that of a shell process of an operating system that receives a command name and command parameters as user input from a keyboard through a command line interface (‘CLI’), forks a child process of the shell process, and executes the command by the child process. The command in this example is an executable file of the computer operating system in which the shell process runs, and the command name is a filename. Readers of skill in the art will recognize that a command name in a shell process may be a name of a ‘built-in’ command, a segment of program instructions included within the shell itself. The illustrated program, for purposes of explanation, however, and not for exclusion, exemplifies commands as executable files.

The illustrated program carries out preliminary preparations by including useful header files (lines 01-04); declaring several variables, arrays, and pointers for use in later processing (lines 07-21); establishing a pipe for use in retrieving return data from the child process (line 24), and establishing an infinite loop for data processing (line 26). The infinite loop for the illustrated program is an attribute of an exemplary shell process intended to run permanently unless killed by an external action.

The illustrated program implements a CLI by prompting for user keyboard input of a command (line 29) and reading into a string named ‘command’ the command name and command parameters (line 32). The illustrated program writes the command into the display buffer (line 33). The pointer to the current buffer offset, the memory address for current writes to the display buffer, is stored in a pointer named ‘cursor.’

The illustrated program resets the cursor to the current buffer offset (line 34). The illustrated program opens a history file for writing (35); marks the command in the history file with an XML tag “<cmd>” (line 36); writes the command to the history file (line 37); marks the command in the history file with XML markup for the return data location in the display buffer, “<returnData location=” (line 38); records the current cursor value for later reference in a variable named ‘lastCursor’ (line 39); converts the cursor value to a string named ‘location’ (line 40); and writes ‘location’ to the history file as the buffer offset or memory address from which current return data may be retrieved later as needed (line 41).

At this point in processing, if the command line entered is:
>CONTACT SHAWN MULLEN
   then the corresponding line in the history file, created by the output from listing lines 36-41, is represented by:
<cmd>CONTACT SHAWN MULLEN<returnData location=

Readers will recognize this history line as a fragment of an XML element named ‘cmd’ which in turn contains a fragment of another XML element named ‘returnData.’ Further processing as described below will complete the XML elements to include a buffer display location for the return data.

The illustrated program forks a child process (line 43); connects the standard output of the child process to the pipe (line 45); parses the command into a data structure useful as parameters in executing the command (line 46); and executes the command (line 47). The command as executed overwrites and replaces the child process and sends its return data to its standard output which is now redirected through the pipe back to the parent shell process. The exec( ) system call represents a family of possible calls that include, for example, execcl( ), execlp( ), execle( ), execv( ), and execvp( ). Each form of the exec( ) call may require a different arrangement of call parameters. The parse( ) function sets up the call parameters as needed by the particular form of exec( ) used in any particular implementation. Any parse and the use of any form of exec( ) as will occur to those of skill in the art is well within the scope of the present invention.

The parent process of the illustrated program continues at line 51. In this example, the parent process determines whether the command succeeds or fails on the basis of a timeout. That is, the parent process sets a signal alarm with a handler function named ‘handler’ (line 55). Here is an example of a handler function:
void handler( ) {flag =1;}

That is, a handler in this example simply sets ‘flag’ to the value ‘1.’ The ‘flag’ is an integer earlier declared and initialized with the value ‘0’ (line 07). The signal alarm is set for five seconds. If the parent process waits more than five seconds for the child to terminate, the alarm is activated, and the handler is called. Processing then continues just after the wait( ) system call (line 56). Five seconds is used as an example of a time limit beyond which it is undesirable to wait for command execution, so that a command taking more than five seconds to execute will be considered to have ‘hung’ or failed to execute successfully. Five seconds is for explanation, not for limitation. Any time limit may be used as will occur to those of skill in the art.

The parent process sets the signal alarm and then waits (line 56) for the child process to execute the command. If the parent process waits less than five seconds, in this example, the execution of the command is considered successful. The signal alarm is not activated, the value of the ‘flag’ integer remains ‘0,’ and parent processing continues with lines 61-70, where the parent process reads the return data from the pipe (line 62) into an interim buffer named ‘returnData,’ which was declared and set up with pointers earlier at lines (lines 17-18). The parent process then writes the return data to the display buffer (line 64); writes the display buffer location of the return data to the history file (line 65a); places a string value of the quantity of return data in a string named ‘quantity’ (line 66); and marks the history file with the quantity of return data (lines 67-68); closes the <returnData> tag in the history file (line 69); and closes the <cmd>tag in the history file (line 70). In this example, the display buffer location is implemented as the beginning memory address of the return data, that is, the value of lastCursor in line 65a, supplemented by the quantity of return data. Buffer display location may be implemented also with a beginning memory address and an ending memory address, and in other ways as will occur to those of skill in the art.

At this point in processing, continuing with the example command line:
>CONTACT SHAWN MULLEN
   the corresponding line in the history file, created by the output from listing lines 36-41 and listing lines 67-70, may be represented by:
<cmd>CONTACT SHAWN MULLEN<returnData location=0x00FF0A12 quantity=64></cmd>
   where ‘0x00FF0A12’ is a hexadecimal representation of a 32 bit memory address where the return data is stored in the display buffer and ‘64’ is the quantity of return data, expressed in bytes, stored at that memory address.

The parent process sets the signal alarm (line 55) and then waits (line 56) for the child process to execute the command. If the parent process waits more than five seconds, the execution of the command is treated as having timed out, a failure to execute successfully. The signal alarm is activated, the handler sets the ‘flag’ integer to ‘1,’ and parent processing continues at line 72.

The parent process finds the command in the history file, loads the history line containing the command into a buffer named ‘hLine’ for ‘history Line,’ and loads a pointer named ‘histPtr’ with the memory address of the command in the hLine buffer (line 75). That is, histptr now points to the command name in computer memory. The parent process then loads a pointer named ‘startPtr’ with the beginning address in the hLine buffer of the location of the return data in the display buffer (lines 78-79), points ‘endPtr’ at the end of the address in the hLine buffer of the location of the return data in the display buffer (line 80), and converts the location string from the history line to an integer (lines 81-83). The parent process now has an integer named ‘location’ that contains the memory address of the beginning of the return data in the display buffer.

The next task is to calculate the size or quantity of the return data in the display buffer. The parent process next loads startPtr to point to the end of the ‘quantity=’ parameter in the <returnData> tag in the history line, that is, to point to the beginning of the field in which a quantity string is stored representing the quantity of return data for the command in the display buffer (lines 86-87). The parent process then loads endPtr with the address of the end of the quantity string representing the quantity of return data for the command in the display buffer (line 88). The parent process then converts the quantity string to an integer named ‘quantity’ (lines 90-92).

The parent process now has an integer named ‘quantity’ that contains the size or quantity of the return data in the display buffer as well as an integer named ‘location’ that contains the memory address of the beginning of the return data in the display buffer. The pointer named ‘cursor’ points to the present write position for return data in the display buffer. The parent process next warns the user that the shell is now going to display previous data (line 95) and writes the return data from the previous execution of the command to the display buffer at the current cursor position (line 97).

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of administering return data from execution of commands by a computer operating system, the method comprising:
receiving in the operating system a command name and optional command parameters specifying a command for current execution, the command having been previously executed; and
displaying return data from the previous execution of the command.

2. The method of claim 1 wherein the command is an executable file of the computer operating system, receiving the command name and command parameters is carried out by a shell process of the operating system, and the previous execution of the command further comprises:
forking a child process of the shell process; and
executing the command by the child process.

3. The method of claim 1 further comprising attempting to execute the command and display current return data from the command, wherein the command fails to execute.

4. The method of claim 3 wherein the command's failure to execute further comprises the command's timing out.

5. The method of claim 3 wherein the command's failure to execute includes a user's interrupting execution of the command.

6. The method of claim 1 wherein receiving the name and parameters specifying a command for current execution further comprises receiving an instruction to display the return data from the previous execution of the command.

7. The method of claim 1 further comprising:
marking the command in a history file upon the previous execution of the command, including recording a display buffer location of the return data from the previous execution of the command,
wherein displaying return data from the previous execution of the command includes:
retrieving from the history file the display buffer location of the return data from the previous execution of the command; and
reading from a display buffer the return data from the previous execution of the command in dependence upon display buffer location.

8. A system for administering return data from execution of commands by a computer operating system, the system comprising:
means for receiving in the operating system a command name and optional command parameters specifying a command for current execution, the command having been previously executed; and
means for displaying return data from the previous execution of the command.

9. The system of claim 8 further comprising means for attempting to execute the command and display current return data from the command, including means for detecting a failure to execute the command.

10. The system of claim 9 wherein the failure to execute the command further comprises the command's timing out.

11. The system of claim 9 wherein the failure to execute the command further comprises a user's interrupting execution of the command.

12. The system of claim 8 wherein means for receiving the name and parameters specifying a command for current execution further comprises means for receiving an instruction to display the return data from the previous execution of the command.

13. The system of claim 8 further comprising:
means for marking the command in a history file upon the previous execution of the command, including means for recording a display buffer location of the return data from the previous execution of the command,
wherein means for displaying return data from the previous execution of the command includes:
means for retrieving from the history file the display buffer location of the return data from the previous execution of the command; and
means for reading from a display buffer the return data from the previous execution of the command in dependence upon display buffer location.

14. A computer program product for administering return data from execution of commands by a computer operating system, the computer program product comprising:
a recording medium;
means, recorded on the recording medium, for receiving in the operating system a command name and optional command parameters specifying a command for current execution, the command having been previously executed; and
means, recorded on the recording medium, for displaying return data from the previous execution of the command.

15. The computer program product of claim 14 wherein the command is an executable file of the computer operating system, means, recorded on the recording medium, for receiving the command name and command parameters comprises a shell process of the operating system, and the previous execution of the command further comprises:
means, recorded on the recording medium, for forking a child process of the shell process; and
means, recorded on the recording medium, for executing the command by the child process.

16. The computer program product of claim 14 further comprising means, recorded on the recording medium, for attempting to execute the command and display current return data from the command, including means, recorded on the recording medium, for detecting a failure to execute the command.

17. The computer program product of claim 16 wherein the failure to execute the command further comprises the command's timing out.

18. The computer program product of claim 16 wherein the failure to execute the command further comprises a user's interrupting execution of the command.

19. The computer program product of claim 14 wherein means, recorded on the recording medium, for receiving the name and parameters specifying a command for current execution further comprises means, recorded on the recording medium, for receiving an instruction to display the return data from the previous execution of the command.

20. The computer program product of claim 14 further comprising:
means, recorded on the recording medium, for marking the command in a history file upon the previous execution of the command, including means, recorded on the recording medium, for recording a display buffer location of the return data from the previous execution of the command,
wherein means, recorded on the recording medium, for displaying return data from the previous execution of the command includes:
means, recorded on the recording medium, for retrieving from the history file the display buffer location of the return data from the previous execution of the command; and
means, recorded on the recording medium, for reading from a display buffer the return data from the previous execution of the command in dependence upon display buffer location.
